(19) United States
(12) Patent Application Publication
(10) Pub. No.: US 2022/0087284 A1
(43) Pub. Date: Mar. 24, 2022

(54) SYSTEM FOR DELIVERING FROZEN OR CHILLED BEVERAGES

(71) Applicant: SOCIETE DES PRODUiTS NESTLE S.A., Vevey (CH)

(72) Inventor: Gregory Savioz, Saxonne (CH)

(21) Appl. No.: 17/417,929

(22) PCT Filed: Dec. 20, 2019
(86) PCT No.: PCT/EP2019/086787

§ 371 Date: Jun. 24, 2021

(30) Foreign Application Priority Data
Dec. 26, 2018 (EP) 18215896.4

(51) Int. Cl. A23G 9/04; A23G 9/10; A23G 9/22

(52) U.S. Cl. CPC A23G 9/045; A23G 9/224; A23G 9/103

(57) ABSTRACT

The invention relates to a system (100) for delivering frozen or chilled beverages. The system (100) comprises a device (10) and a container (20), the container (20) comprising a frozen product and the device (10) being configured for receiving the container (20) and for processing the frozen product of the container (20) to deliver the final beverage. The device (10) comprises: a slicing element (60), the slicing element (60) and the frozen product being relatively rotatable to each other about a rotation axis in order to slice the frozen product, and a driving unit (50) configured to provide the relative rotation between the slicing element (60) and the frozen product. The container (20) comprises a container inner wall (301) being in contact with the frozen product, wherein the container inner wall (301) has a cross-section, which is shaped such that a relative rotation between the container (20) and the frozen product about the rotation axis is blocked.

### 1. FIELD OF THE INVENTION

The present invention relates to a system and a method for delivering frozen or chilled beverages.

### 2. TECHNICAL BACKGROUND

At present, the offer for beverage preparation devices (machines) delivering frozen beverages is relatively limited. The most known devices are granita devices embedding a cooling unit (compressor) and thus being very bulky and heavy, thus not suitable for home applications. Moreover, these devices are conceived for the preparation of large quantities of beverages and so need very long times to be ready for operation (typically, several hours). Similarly, water fountains and other cold beverage devices exist but do not guarantee real cold beverages and the products are often very limited, so they do not offer a real alternative to chilled ready-to-drink products.

Most frozen beverage devices known in the prior art, for example as described in document US 2011297272 A1, are very bulky and require the use of large cooling units; in fact, they are conceived for business applications (B2B). Some other devices known in the prior art disclose the dispensing of liquid product together with shaved ice (from water ice cubes) directly into a blending unit, being then blended, as per documents U.S. Pat. Nos. 5,960,701, 5,619,901 or US 2010151083 for example. However, these documents also disclose big and bulky devices not adapted to be easily used in home applications.

Devices for preparing the so called granita beverages are also known in the state of the art as per documents US 2012055189 A1 or US 2004060307 A1. However, the devices described in these documents are also voluminous devices, requiring long operation times and not adapted for home applications. In the prior art, there is also known a more compact system than the devices above. This system comprises a device, which prepares a frozen or chilled beverage by driving a frozen product in rotation and displacing the frozen product towards a slicing element such as a blade in order to slice the frozen product and subsequently use the sliced frozen product for the frozen or chilled final beverage. The system requires a direct interface between the frozen product and the device in order to rotate and displace the frozen product for slicing the frozen product. Usually, a claw of the device claws the frozen product and drives the frozen product in rotation for slicing the frozen product. Using the direct interface between the frozen product and the claw has several drawbacks. For example, the direct contact with the frozen product soils the claw, thereby negatively affecting the hygiene of the device and system, since the claw has to be cleaned regularly and may affect the quality of subsequently processed frozen products. Furthermore, since the claw is in direct contact with the frozen product, there is the risk that the claw will break the frozen product or get in direct contact with the slicing element. That is, there is also the risk that both the claw and the slicing element will be damaged by the moving claw.

Therefore, it is an object of the present invention to provide a system and a method, which overcome the afore-mentioned drawbacks. In particular, it is an object of the present invention to provide a system, which reduces the contact between the frozen product and the system to a minimum for improving the hygiene and the durability of the device. Furthermore, the system should provide a simple and low cost preparation of frozen or chilled beverages.

These and other objects, which become apparent upon reading the following description, are solved by the subject-matter of the independent claims. The dependent claims refer to preferred embodiments of the invention.

### 3. SUMMARY OF THE INVENTION

According to a first aspect of the invention, a system for delivering frozen or chilled beverages comprises a device, a container, the container comprising a frozen product and the device being configured for receiving the container and for processing the frozen product of the container to deliver the final beverage. The device comprises a slicing element, the slicing element and the frozen product being relatively rotatable to each other about a rotation axis in order to slice the frozen product, and a driving unit configured to provide the relative rotation between the slicing element and the frozen product. The container comprises a container inner wall being in contact with the frozen product, wherein the container inner wall has a cross-section, which is shaped such that a relative rotation between the container and the frozen product about the rotation axis is blocked.

In other words, the container inner wall connects to the frozen product by a form fit. This form fit effects a counter force against a rotation of the frozen product relative to the container about the rotation axis, thereby blocking this relative rotation between the container and the frozen product. In particular, a cross-section having only a substantially round shape cannot effect such a form fit and the so effected counter force or blockage, since due to the constant diameter of the round shaped cross-section there is no part of the cross-section, which could stay in the way of the frozen product, when the frozen product rotates about the rotation axis.

Thus, the relative rotation between the frozen product and the slicing element about the rotation axis in order to slice the frozen product can be effected by remaining the container and thus the frozen product stationary and rotating the slicing element about the rotation axis, by rotating the container and thus the frozen product about the rotation axis and remaining the slicing element stationary, or by rotating the container and thus the frozen product as well as the slicing element about the rotation axis in opposite directions. Thereby, for providing the relative rotation between the frozen product and the slicing element, no direct contact between device parts and the frozen product is required, thus resulting in an improved hygiene and durability of the device. The blocking of the relative rotation between the container and the frozen product is thus also independent from the aggregate condition of the frozen product (which particularly affects the adhesion or frictional forces between the container inner wall and the frozen product), e.g. even when the frozen product begins to melt or melts, a relative rotation between the container and the frozen product can be blocked by the shape of the cross-section of the container inner wall.

Preferably, the slicing element is provided to remain stationary about the rotation axis, and wherein the driving unit is configured to rotate the container and thus the frozen product about the rotation axis, thereby providing the relative rotation between the slicing element and the frozen product in order to slice the frozen product. In other words, the shape of the cross-section of the container inner wall effects that a rotation of the driving unit can be transmitted (transferred) to the frozen product by way of the container. Thus, a direct connection between the driving unit and the frozen product in order to rotate the frozen product relative to the slicing element can be omitted, resulting in a compact system with an improved hygiene.

Preferably, the container and thus the frozen product are provided to remain stationary about the rotation axis, and wherein the driving unit is configured to rotate the slicing element about the rotation axis, thereby providing the relative rotation between the slicing element and the frozen product in order to slice the frozen product. Thus, the shape of the cross-section of the container inner wall effects that the frozen product cannot rotate with respect to the stationary provided container, while the rotating slicing element slices the frozen product. As such, the driving unit is not required to rotate the container for slicing the frozen product.

The cross-section of the container inner wall may be elliptically shaped and/or comprises at least one straight section and/or at least one round section. As such, the relative rotation between the frozen product and the container can be effectively blocked, i.e. a particularly good form fit between the container inner wall and the frozen product can thus be provided.

Preferably, the cross-section of the container inner wall has the shape of a polygon, e.g. of a triangle, a rectangle, a square, a pentagon, a hexagon, a heptagon, an octagon, or a circle segment.

The cross-section of the container inner wall may be uniform along the rotation axis and/or wherein the cross-section of the container inner wall extends substantially only along the rotation axis. Thus, the container and the cross-section of the container inner wall can be easily manufactured. Furthermore, since the entire container inner wall along the rotation axis or the symmetry axis connect to the frozen product by the shape of the cross-section of the container inner wall, an effective form fit or blockage between the container and the frozen product can be effected.

The container may comprise a moveable lid, wherein the driving unit is preferably configured to displace the lid in order to displace the frozen product towards the slicing element. In other words, the displacing movement of the driving unit for displacing the frozen product towards the slicing element is transferred to the frozen product by way of the lid. The displacing movement facilitates a more effective slicing of the frozen product due to the so effected pushing of the frozen product against the slicing element. As such, slicing of the frozen product is more effective, while not having any direct contact between the device and the frozen product. Furthermore, the lid functions as a protection for the driving unit or the driving element facilitating the displacing movement so that the driving unit or said driving element cannot come in direct contact with the sliding element.

The lid may have a cross-section, which has a shape, which corresponds to the shape of the cross-section of the container inner wall such that the lid is guidable by the corresponding shapes of the cross-sections of the container inner wall and the lid for displacing the frozen product towards the slicing element. Thus, the lid can be effectively displaced for an effective displacement of the frozen product. Furthermore, the connection by way of the corresponding shapes of the lid and the container inner wall (i.e. a form fit connection) facilitates that a rotation of the lid is transferred to the container inner wall and thus to the container and the frozen product.

The lid may comprise a circumferential edge, wherein the circumferential edge comprises a sealing element for closing the container by the lid in a sealing manner. Thus, degrading of the frozen product by way of the opening sealingly closed by the lid can be prevented.

Preferably, the sealing element is a sealing lip and/or integrally formed with the lid.

The frozen product may be displaceable through an opening of the container in order to be displaced towards the slicing element, wherein the container comprises a further lid for closing the opening of the container. Thus, the further lid, e.g. a membrane, effects that the food product is not degraded, when the frozen product is not yet displaced through the opening, i.e. prior to the processing of the frozen product. The further lid is preferably designed for being opened or removed manually and/or to open, when the frozen product is displaced through the opening and towards the slicing element. For example, the further lid may comprise weakened regions, which facilitate the opening of the further lid, e.g. when the food product pushes against the further lid for being displaced through the opening. Thus, the further lid can be easily opened without affecting the container.

Preferably, the container comprises a container outer wall comprising a cross-section being shaped for transferring a rotation of the driving unit of the system about the rotation axis to the container and thus the frozen product. Thus, a rotation of the system can be effectively transferred to the container and, thus, to the frozen product by form fit only. For example, the driving unit or a driving element of the driving unit grabs the container outer wall for transferring a rotational movement of the driving unit to the container. As such, no clamping force for clamping the container is required, thereby also preserving the container from mechanically degrading.

The shape of the cross-section of the container outer wall preferably corresponds to the shape of the cross-section of the container inner wall. Thus, the container may have a constant wall thickness. Thereby, the container can be manufactured more efficiently.

The container may comprise an (machine-readable) identification element, e.g. a barcode and/or an RFID tag, wherein the identification element comprises processing parameters for processing the container by the system and/or information of the frozen product contained by the container, wherein, preferably, the container outer wall comprises the tag.

The system may further comprise an injection unit for providing a jet of liquid to the sliced product in order to dissolve and/or homogenize and/or hydrate the final beverage.

The system may further comprise a heating unit adapted to be coupled with the container to at least partially detach the frozen product inside the container before it is sliced. In other words, the heating unit effects that the frozen product cannot adhere to the container inner wall by adhesion or a frictional force anymore. However, the shape of the cross-section of the container inner wall still effects that a relative rotation between the frozen product and the container about the rotation axis is still prevented/blocked. As such, for example the gravitational force and/or the driving unit facilitates the displacement of the food product towards the slicing element, while the form fit between the shape of the cross-section of the container inner wall and the frozen product still effects due to the so effected counter force the relative rotation between the slicing element and the frozen product in order to slice the frozen product.

The system may comprise a mixing chamber for receiving the sliced product, wherein, preferably, the injection unit is provided for injecting the jet of liquid into the mixing chamber.

The mixing chamber preferably comprises a stirring element for stirring the sliced product in the mixing chamber. Thus, the final beverage in the mixing chamber can be more effectively homogenized.

The system may comprise a control unit for controlling at least the driving unit, the injection unit, the heating unit and/or the stirring element.

The control unit may be configured to read the identification element of the container and to control the driving unit, the injection unit, the heating unit and/or the stirring element according to the processing parameters.

According to a second aspect of the invention a method for delivering frozen or chilled beverages with a system as described above comprises the following steps: providing a relative rotation between the slicing element and the frozen product about a rotation axis in order to slice the frozen product, and blocking a relative rotation between the container and the frozen product about the rotation axis by the shape of the cross-section of the container inner wall.

The above description and advantages of the system applies analogously to the method.

### 4. DESCRIPTION OF PREFERRED EMBODIMENTS

In the following, the invention is described exemplarily with reference to the enclosed figures, in which

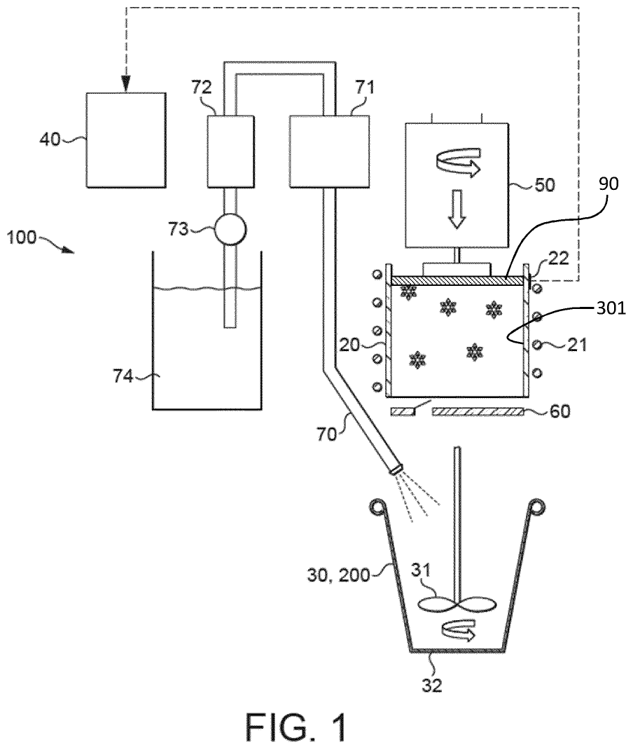

FIG. 1 shows a schematic view of a system for delivering frozen or chilled beverages according to one embodiment of the invention, where the frozen product in the container simultaneously rotates and displaces towards stationary slicing element;

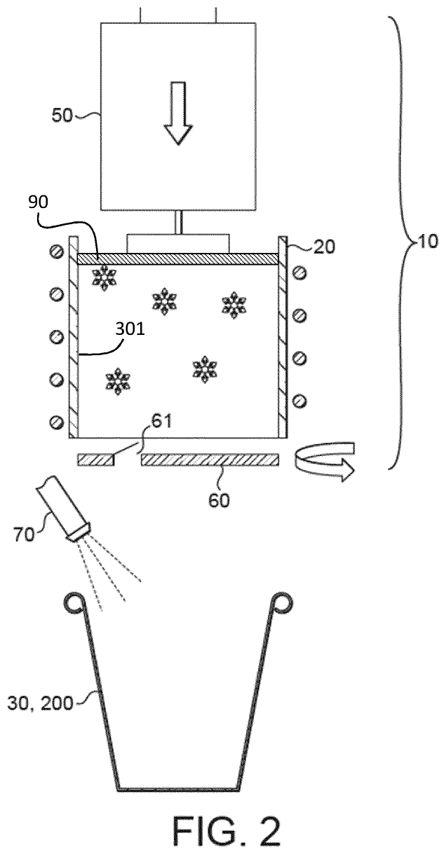

FIG. 2 shows a schematic view of a system for delivering frozen or chilled beverages according to another embodiment of the invention, where the frozen product in the container displaces towards the slicing element, while the slicing element moves in rotation;

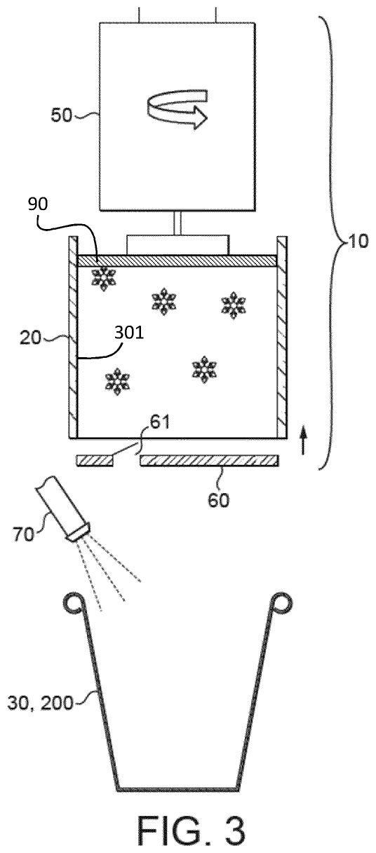

FIG. 3 shows a schematic view of a system for delivering frozen or chilled beverages according to yet another embodiment of the invention, where the frozen product of the container rotates while the slicing element displaces inside the container towards the product in it;

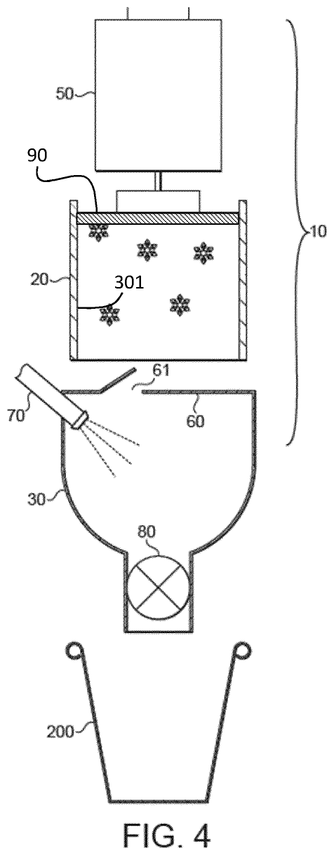

FIG. 4 shows a schematic view of a system for delivering frozen or chilled beverages according to the invention, further comprising a mixing chamber receiving the sliced product and injection means providing a jet of liquid into the mixing chamber;

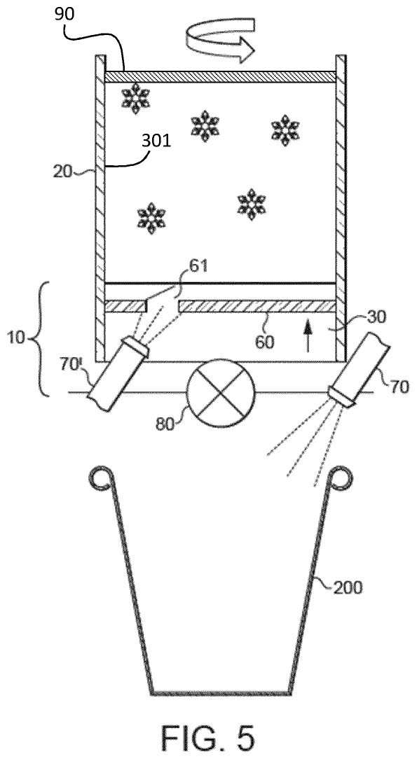

FIG. 5 shows a schematic view of a system for delivering frozen or chilled beverages according to the invention, wherein the container is provided with a mixing chamber;

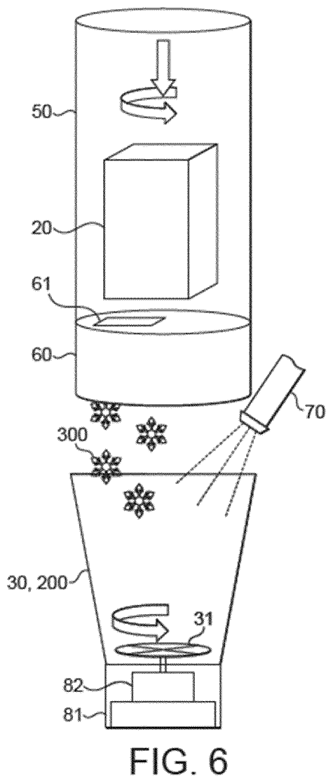

FIG. 6 shows a schematic view of a system for delivering frozen or chilled beverages according to the invention, further comprising a mixing chamber provided with a stirring element rotatable within said mixing chamber;

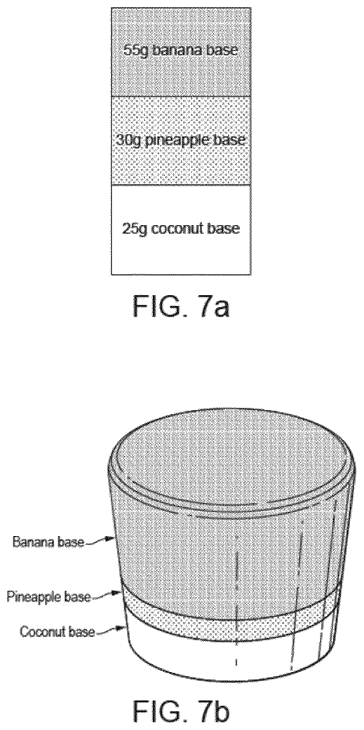

FIGS. 7a-b show schematically an example of a frozen product recipe to be prepared in a system for delivering frozen or chilled beverages according to the invention;

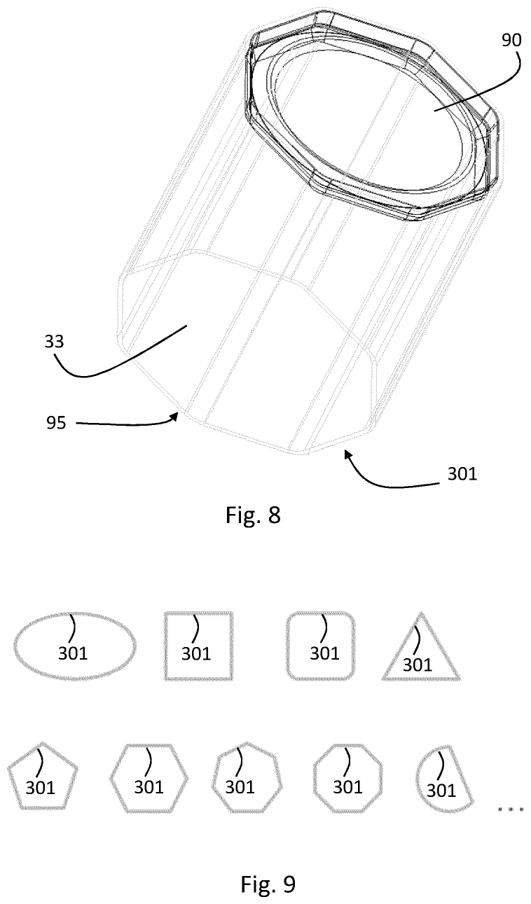

FIG. 8 shows a schematic perspective view of a container to be used in the system for delivering frozen or chilled beverages according to the invention;

FIG. 9 shows preferred shapes for the cross-section of a container inner wall of a container to be used in the system for delivering frozen or chilled beverages according to the invention;

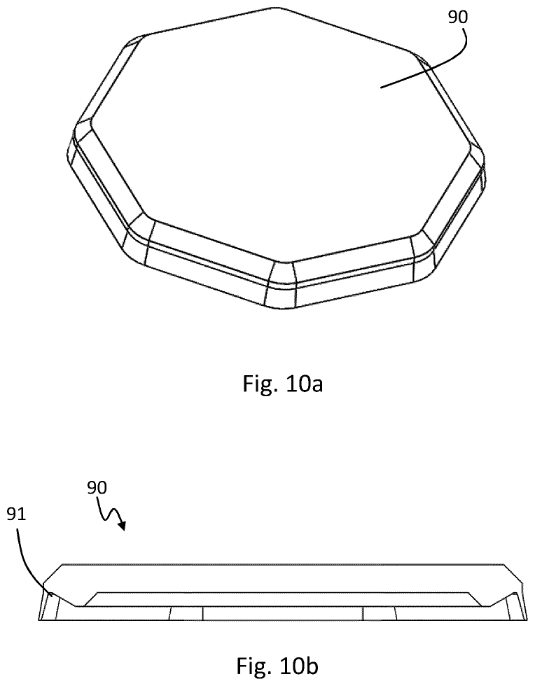

FIG. 10a-b show schematically perspective view and a cross-sectional view, respectively, of a preferred lid of the container shown in FIG. 8;

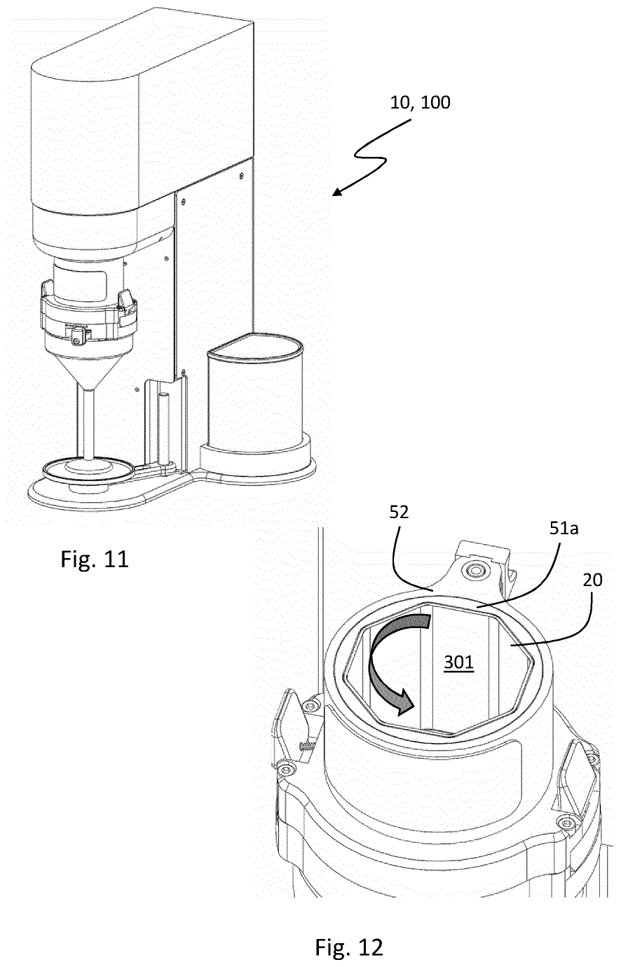

FIG. 11 shows a schematic perspective view of a system for delivering frozen or chilled beverages according to a preferred embodiment of the invention;

FIG. 12 shows a schematic perspective detailed view of the system shown in FIG. 11; and

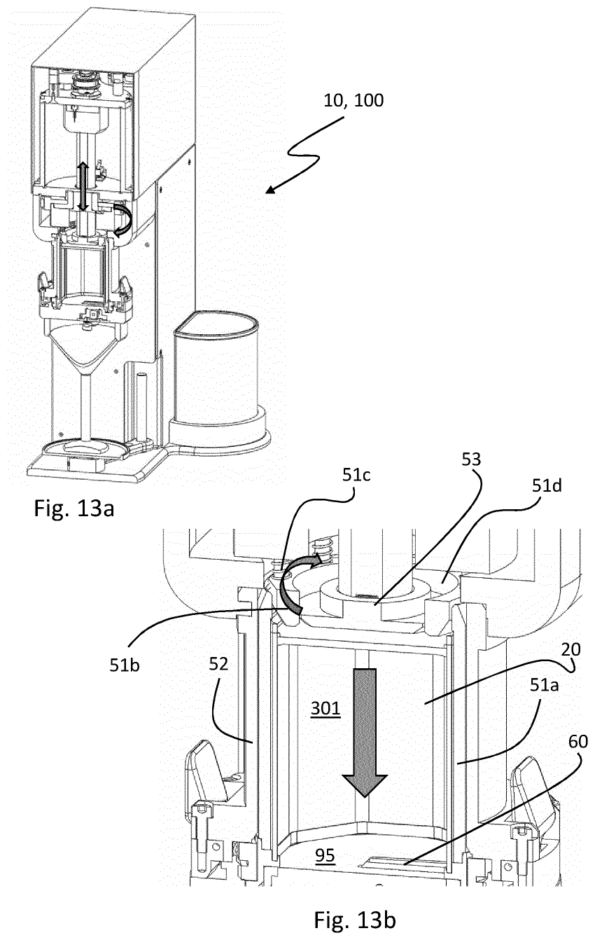

FIGS. 13a-b show a schematic perspective cross-sectional view and a detailed schematic perspective cross-sectional view, respectively, of the system shown in FIGS. 11 and 12.

The system 100 of the invention comprises a container 20 and a device 10, as represented for example in FIG. 2. The container 20 comprises a frozen product inside and the device 10 is configured for receiving the container 20 and for processing the product in the container 20 in order to deliver the final beverage. The product in the container 20 can be completely or partially frozen. The product inside the container 20 is typically coming from a natural and fresh product that is frozen before being used in the system 100 to prepare the frozen or chilled beverage from it. The idea is that, once the container 20 having inside the frozen product is attached to the device 10, the frozen product is sliced into flakes or small slices of product (still frozen) that will be sent into a cup or recipient 200, where a jet of liquid (typically water) will be added in order to prepare the final beverage. For producing the flakes or slices of frozen product, the system 100 will comprise a slicing element 6o relatively rotatable (moveable) about a rotation axis and with respect to the frozen product in the container 20, so as to slice it. Different ways of moving the two (frozen product and slicing element) relative to each other can be envisaged, as it will be further explained in more detail in what follows.

The system 100 further comprises a driving unit 50 configured to provide the relative motion of the slicing element 60 and the frozen product in the container 20, as shown in FIG. 1. As further represented in this Figure, the system 100 further comprises an injection unit 70 providing a jet of liquid to the sliced product (the sliced product was sent to the recipient or cup 200) in order to dissolve and/or homogenise and/or hydrate the final beverage.

The frozen product can be driven indirectly by the driving unit 50 through the container 20. This means that, for example, in the case where you move the container 20 by rotation, the frozen product inside of it moves together with the container 20 (i.e. there is no sliding between container and the frozen product and they move solidarily). According to the invention, the shape of the cross-section of the container inner wall 301 of the container 20 can facilitate such an indirect drive of the product, as will be described in the following in more detail. The driving unit 50 may be configured to displace or push the frozen product downwards by linear movement towards the slicing element 60 and preferably along the rotation axis, so there is a vertical sliding of the frozen product with respect to the container inner wall 301, while both (container and frozen product) rotate at the same time.

As represented in FIG. 1, the injection unit 70 is configured to provide a jet of liquid to the frozen product sliced and they are thus connected to a water tank 74 through a water pump 72. Preferably, a flow meter 73 to control the flow of the jet injected is further provided and optionally also a heater 71, in order to offer the possibility of adding a hot jet of liquid instead. The jet of liquid provided by the injection unit 70 can be delivered into different shapes and/or configurations, such as a shower, having a conical shape, as a straight line, etc. Also, the injection unit 70 can be made moveable with respect to the product, in order to provide a faster speed of homogenization, hydration, mixing, or the like.

In the system 100, the type and characteristics of the beverage delivered depend on one or a plurality of the following parameters: the speed of the relative motion of the slicing element 60 and of the frozen product in the container 20, the positioning of the frozen product within the system 100 and the temperature and/or quantity and/or flow rate of the jet of liquid provided to the frozen product, as well as the positioning of the interstice in the slicing element 60.

Different embodiments will be now presented covering different possibilities of the relative rotational motion of the frozen product of the container 20 about the rotation axis and with respect to the slicing element 60. One embodiment is represented by schematic arrows in FIG. 1, where the frozen product of the container 20 simultaneously rotates and displaces towards the slicing element 60, and the slicing element 60 remains stationary. The slicing element 60 typically comprise a blade with an interstice 61 through where the frozen product will be sliced in small slices or flakes by the movement in rotation and displacement of the said block of frozen product with respect to the stationary blade and interstice 61. According to a possible embodiment of the invention, the height of this interstice 61 will be fixed but, according to another possible embodiment, this height can be regulated as desired (by means of a pivotable part, for example, rotating at one point).

Another possibility is represented in FIG. 2: here, the frozen product in the container 20 displaces towards the slicing element 60 while the slicing element 60 moves in rotation. This relative movement of the frozen product and the slicing element makes it possible to produce small slices or flakes of frozen product, similarly as in the previous case described.

FIG. 3 represents a further possible embodiment where the frozen product in the container 20 rotates while the slicing element 60 displaces inside the container 20 and towards the frozen product in it, in order to similarly produce slices or flakes of frozen product.

Still another embodiment is possible wherein the slicing element 60 simultaneously rotates and displaces inside the container 20 and with respect to the frozen product in it, which remains stationary, thus to produce the small slices or flakes of frozen product.

In order to make the frozen product inside the container 20 move with respect to the slicing element 60 (rotating and displacing as in FIG. 1 or FIG. 6, displacing downwards as in FIG. 2 or simply rotating as in FIG. 3 or 5), the container 20 can optionally be provided with a heating unit 21 (see FIG. 1) that facilitates detaching, at least partially, the frozen product from the inner wall of the container 20, in order to initiate the movement of the product towards the slicing element 60 (movement thereafter may be continued by the driving unit 50). Depending on the product nature, it may be particularly advantageous to detach the frozen product from inside the container 20 by heating or pre-heating.

In another embodiment of the invention, the system 100 is further provided with a mixing chamber 30 to where the slices or flakes of frozen product are sent. There are several possibilities of incorporating this mixing chamber 30 in the overall system 100: the mixing chamber 30 can be the same as the recipient or cup 200 where the final beverage will be served (see for example FIG. 1 or FIG. 6) or it can be a separate part of the system (see FIG. 4) or it can be made as a separate part into the container 20 (see FIG. 5). In the example shown in FIG. 4, the flakes or slices of frozen product coming from the product inside the container 20 are sent into a mixing chamber 30 to where the injection unit 70 provides the jet of liquid in order to mix, homogenise, dissolve or hydrate the product before it is delivered into a recipient or cup 200. A valve 80 arranged at the exit of the mixing chamber 30 controls the flow of the beverage into the recipient or cup 200, as represented in FIG. 4.

Another example is shown in FIG. 5, where the mixing chamber 30 is arranged in the container 20: the frozen product inside the container 20 is made to rotate (after having been optionally detached by way of being heated from the inner walls of the said container 20, for example) and, while it is rotating, the slicing element 60 is configured to displace vertically upwards towards the rotating product. The volume of said mixing chamber 30 is variable depending on the relative movement of the slicing element 60 with respect to the product. This relative movement provides slices or flakes of frozen product into a mixing chamber 30, which is configured in the container 20 itself, as represented in this FIG. 5. Secondary injection unit 70′ can optionally be provided and configured to inject a jet of fluid (typically water) into this mixing chamber 30 to first mix, homogenize, hydrate and/or dissolve the flakes or slices of frozen product in that chamber 30. A valve 80 is arranged at the exit of the mentioned mixing chamber 30 in order to control the dispensing of the product in the said chamber into a recipient or cup 200. Further injection unit 70 are configured to add a jet of liquid into the recipient 200 so as to prepare the final beverage. Both injection units 70 and 70′ can be provided or any one of the two, depending on different embodiments of the system of the present invention.

In the preferred embodiment of the system 100 shown in FIG. 6, the mixing chamber 30 further comprises a stirring element 31 rotatable within the inner volume of said mixing chamber 30. The frozen product inside the container 20 rotates and displaces vertically downwards towards slicing element 60, typically a blade, having a blade interstice 61, so that the frozen product is sliced (turned into small pieces, slices or flakes of frozen product 300). The sliced product 300 goes into a mixing chamber 30 (in this embodiment, the same as the recipient or cup 200) where an injecting unit 70 injects a jet of liquid to prepare the beverage. The mixing chamber 30 comprises a stirring element 31, typically configured as a whisk, rotatable within said chamber 30 by means of a motor 82 and controlled with the aid of a control unit 81. This control unit 81 can be rechargeable or inductive and/or can be made connectable to a power source.

In the preferred embodiment shown in FIG. 1, the mixing chamber 30 is also the recipient or cup 200 for the final beverage, to where the slices or flakes of frozen product are sent, and to where the jet of liquid from the injection unit 70 goes. In this embodiment, the device 10 further comprises a stirring element 31 rotatable by the driving unit 50 in the device 10. The stirring element 31 is preferably configured as a whisk. Optionally, the mixing chamber 30 can be provided with a further heating unit 32 to improve final mixing and homogenization of the beverage and/or to control the final beverage temperature. Also, the stirring element 31 can provide a certain level of foaming in the final beverage dispensed, when desired.

Preferably, the container 20 is provided with an identification element 22 (see for example FIG. 1, e.g. provided on the container outer wall 33): this identification element 22 comprises information on the product in the container 20 and/or on the processing parameters of the said product, such as: speed of the relative motion of the slicing element 60 and of the product, positioning of the frozen product within the system, temperature and/or quantity and/or flow rate of the jet of liquid provided. The system of the invention will typically further comprise a control and/or reading unit 40 configured to read the information in these identification element 22 and to actuate the device 10 according to the corresponding processing parameters. The control unit 40 will typically comprise a human-machine interface (HMI). With the system 100 it is also possible to prepare beverages having different products departing from a layered initial frozen product, as for example represented in FIGS. 7a and 7b. Departing for example from a frozen product as shown in these Figures, comprising for example coconut, pineapple and banana, in exemplary quantities of 25 grams, 30 grams and 55 grams, for example, the final beverage prepared by the system will comprise these, as these components will be progressively sliced and sent into the final beverage. As different possibilities of slicing (shape and/or size of the flakes delivered) and/or quantity of liquid, typically water, provided to make the dissolution, the textures of the product provided into the beverage may be adapted. It is evident that other compositions and layers can be similarly used in the system of the invention. Compositions of products as solid products, liquid products, leaves (of basil, for example), purées, entire foods etc. could also be included in the frozen product in the container 20 so as to be delivered in the final beverage dispensed.

An important aspect of the present invention is the specifically designed shape of the container inner wall 301, which facilitates, in particular, that the contact between the frozen product and the device 10 can be reduced to a minimum, thereby also improving the hygiene and the durability of the device 10 and system 100. This and other preferred advantageous aspects of the container 20 will be described in the following with respect to FIGS. 8 to 13b.

FIG. 8 exemplarily shows the container 20 according to a preferred embodiment of the present invention. The container 20 comprises a container inner wall 301 with a cross-section, which—in a top view, i.e. when viewed in the direction of the rotation axis of the container 20 or, preferably, along the symmetry axis of the container 20—has such a shape that a relative rotation between the container 20 and the frozen product being in contact with the container inner wall 301 is blocked. In other words, the cross-section of the container inner wall 301 connects to the frozen product by form fit, thereby blocking the relative rotation between the container 20 and the frozen product about the rotation axis; in contrast, a circular or round shaped cross-section, i.e. a cross-section having a closed circle, of the container inner wall 301 cannot effect this blockage, the frozen product would rather rotate along the container inner wall 301 in a sliding manner. Blocking of said relative rotation facilitates that a force and torque can be transmitted between the container 20 and the slicing element 60. Thereby, the frozen product can remain stationary by holding the container 20, or can be rotated indirectly by the driving unit 50 rotating the container 20 in order to slice the frozen product. Thus, any direct contact between the device 10 and the frozen product can be omitted in order to slice the frozen product.

In the example shown in FIG. 8, the container inner wall 301 has a cross-section, which is shaped as an (regular) octagon. However, the present invention is not limited to a particular cross-section, as long as the cross-section has such a shape that the relative rotation between the frozen product and the container inner wall 301 can be blocked. Preferably, the cross-section has no (closed) round shape.

FIG. 9 shows further exemplary shapes of the cross-section of the container inner wall 301. As shown in FIG. 9, the cross-section is preferably elliptically shaped and/or comprises at least one straight section and/or at least one round section and/or at least one, preferably at least two edges (e.g. rounded edge(s)). In particular, the cross-section may have the shape of a (regular) polygon. For example, (from the first line to the second line and from the left to the right in FIG. 9) the cross-section may have the shape of an ellipse, a rectangle or square, a rectangle or square having rounded edges, a (regular) triangle, a (regular) pentagon, a (regular) hexagon, a (regular) heptagon, an (regular) octagon, or a circle segment.

In the exemplary container 20 shown in FIG. 8, the cross-section is uniform along the rotation axis, i.e. along the symmetry axis of the container 20 or container body/container inner wall 301. Alternatively, the cross-section may also be only partially uniform along the rotation axis. Having an uniform cross-section of the container inner wall 301 along the whole extending direction of the container 20 along the rotation axis is, however, preferred, since this effects a particularly good blocking effect for blocking the relative rotation between the container 20 and the frozen product inside of the container 20. In this exemplarily shown container 20, the cross-section extends substantially only along the rotation axis, thus the container inner wall 301 extends substantially parallel to the rotation axis. In other examples, the container inner wall 301 may also be inclined with respect to the rotation axis.

As exemplarily shown in a schematic manner in FIGS. 1 to 5 and in more detail in FIGS. 8, 10a and 10b, the container 20 may further comprise a moveable lid 90, e.g. designed in the form of a piston, for displacing the frozen product towards the slicing element 60. As exemplarily shown in FIGS. 1 and 2 and indicated with the straight arrow, the driving unit 50 may be further configured to displace the lid 90, thereby displacing the frozen product towards the slicing element 60 in order to effectively slice the frozen product. In these exemplary examples, the slicing element 60 remains stationary. The slicing element 60 may also move in the inside of the container 20, as exemplary shown in FIGS. 3 and 5, wherein the driving unit 20 displaces the lid 90 and, thus, the frozen product towards the moving (displacing) slicing element 60; alternatively, the lid 90 may also remain stationary, e.g. by providing a counter force on the lid 90 by the driving unit or any other stationary element in contact with the lid 90.

As shown in FIG. 8, the cross-section of the lid 90 has preferably a shape or a circumference, which corresponds to the shape of the cross-section of the container inner wall 301. In the example shown in FIG. 8, the lid 90 has thus a shape in the form of an octagon. Having the corresponding shapes, the lid 90 can be guided for displacing the frozen product towards the slicing element 60. Since the lid 90 is, thus, only moveable along this displacing axis, which is preferably the rotation axis, the lid 90 may also be used for transferring a rotational movement from the driving unit 50 to the container 20 and, thus, to the frozen product.

As exemplarily shown in FIG. 10b, the lid 90 may comprise a circumferential edge, which comprises a sealing element 91 for closing the container 20 by the lid 90 in a sealing manner. That is, the sealing element 91 may be provided such that when the lid 90 closes the container 20 from the top of the container 20, the sealing element 91 is pushed against the container inner wall 301 of the container 20, thereby sealing a gap between the circumferential edge of the lid 90 and the container inner wall 301. The sealing element 91 preferably runs along the entire circumferential edge of the lid 90. The pushing force of the sealing element 91 acting against the container inner wall 301 is thus such that a sufficient sealing is effected, while the pushing force still can facilitate the displacement of the lid 90 along the container inner wall 301. Preferably, the sealing element 91 is a sealing lip. In other examples, the sealing element 91 may also be differently designed, e.g. in the form of an O-ring. The sealing element 91 is preferably integrally formed with the lid 90, i.e. the lid 90 and the sealing element 91 preferably form a monolithic structure.

With reference to the container 20 shown in FIG. 9, the container 20 may comprise an opening 95, in particular provided at the bottom of the container 20. The opening 95 is provided such that the frozen product can be displaced through the opening 95 and towards the slicing element 60. The opening 95 preferably corresponds in shape and size to the cross-section of the container inner wall 301 so that the frozen product can be easily displaced to an outside of the container 20 to be sliced by the slicing element 60.

The container 20 may comprise a further lid (not shown) for closing the opening 95 in order to prevent a degradation of the frozen product by way of the opening 95. The further lid may be glued to the container 20. Preferably, the further lid is designed for being opened or removed manually or to open, when the frozen product is displaced though the opening 95 and towards the slicing element 60. That is, the pushing force of the frozen product acting on the further lid due to the displacement of the frozen product towards the slicing element 60 may remove or tear the further lid such that the frozen product can be displaced through the opening 95. Preferably, the further lid comprises weakened regions (e.g. a thinner wall thickness and/or perforations), which facilitate the tearing or removal of the further lid.

With reference to FIGS. 11 to 13b, a preferred configuration of the driving unit 50 for rotating and/or displacing the frozen product with respect to the slicing element 6o is described.

As previously described, the shape of the cross-section of the container inner wall 301 facilitates that a rotation (and/or torque) of the driving unit 50 can be transferred to the frozen product. According to a preferred embodiment, the driving unit 50 cooperates with the container 20 or container body, preferably with the container outer wall 33. Thus, the container outer wall 33 preferably comprises a cross-section, which is shaped for transferring a rotation of the driving unit 50 about the rotation axis to the container 20 and thus—because of the shape of the cross-section of the container inner wall 301—to the frozen product. As can be seen, e.g., in FIGS. 8 and 12, the shape of the cross-section of the outer wall 33 preferably corresponds to the shape of the container inner wall 301. However, the cross-section of the container outer wall 33 may also be differently shaped than the cross-section of the container inner wall 301, in particular according to the possible shapes for the cross-section of the container inner wall 301 as described herein above. What was said with respect to the container inner wall 301, in particular with respect to its cross-section, applies correspondingly to the container outer wall 33.

As can be seen in FIG. 13a, and in FIG. 13b in more detail, the driving unit 20 may comprise a rotating driving element 51, which has a shape, which at least partially corresponds to the shape of the cross-section of the container outer wall 33 so that the driving element 51 connects to the container outer wall 33 by form fit in order to transfer the rotational movement of the driving unit 50 to the container 20 and, thus, to the frozen product. The driving element 51 may comprise a first part 51a and a second part 51b, which are provided separately from one another. The first part 51a may be provided for receiving the container 20 and for connecting the driving element 51 to the container outer wall 33 by their shapes, i.e. by form fit. The second part 51b may be provided for transferring a rotational movement of the driving unit 50 to the first part 51a and, thus, to the container outer wall 33. The second part 51b may have a shape, which at least partially corresponds to the shape of the first part 51a so that the second part 51b can connect to the first part 51a by form fit, thereby transferring a rotation of the second part 51b to the first part 51a. The second part 51b may be biased towards the first part 51a by at least one elastic element 51c, e.g. a spring such as a coil spring, so that the second part 51b can securely connect to the first part 51a. The biasing force of the elastic element Sic may effect a force for improving the connection between the first part 51a and the second part 51b.

As can be seen in FIGS. 12, 13a and 13b, the driving unit 50 may comprise a fixed part 52 for receiving the driving element 51, the first part 51a of the driving element 51, respectively. In the fixed part 52, the driving element 51, the first part 51a, respectively, is pivotably seated so that the driving element 51, the first part 51a, respectively, can rotate with respect to the fixed part 52.

Referring now to FIGS. 13a and 13b, the driving unit 50 may be further configured to displace the frozen product towards the slicing element 60. More specifically, the driving unit 50 may comprise a linearly moving driving element 53, e.g. in the form of a piston rod, which is provided for cooperating with the lid 90 so that the displacing movement of the driving element 53 can be transferred to the lid 90, thereby displacing the frozen product towards the slicing element 60. Preferably, the driving element 53 extends along the rotation axis of the driving element 51 and/or the displacing direction of the driving element 51 is parallel, preferably flush with the rotation axis of the driving element 51. Preferably, the driving element 51, in particular the second part 51b of the driving element 51, comprises a hole 51d, through which the driving element 53 can extend for cooperating with the lid 90 in order to displace the lid 90 as explained above. As such, the driving elements 51, 53 can be arranged in a compact manner.

A method for using the previously described system 100 comprises the following steps: providing a relative rotation between the slicing element 60 and the frozen product about a rotation axis in order to slice the frozen product, and blocking a relative rotation between the container 20 and the frozen product about the rotation axis by the shape of the cross-section of the container inner wall 301.

The method may further comprise the step of displacing or dispensing the frozen product from the container 20 and slicing it, preferably at a certain rate defined by the relative motion of the slicing element 60 and of the frozen product. The method may further comprise the step of dissolving and homogenizing the sliced product with a jet of liquid provided by the injection unit 70.

The method of the invention may further comprise the step of detaching at least partially the frozen product inside the container 20 before it is sliced, preferably by heating, the heating being typically provided by the heating unit 21, as shown in FIG. 1. Preferably, the detachment of the frozen product from the container is made by heating this product without producing liquid out of it, or a very limited amount of liquid. The heating unit 21 can be resistive, induction, infrared, hot air, etc. The preferred execution will be using a hot air heating unit 21 because of its simplicity.

The method of the invention can further comprise the step of retrieving information in the identification element 22 in the container 20 and actuating the device 10 according to corresponding processing parameters, depending on the type of frozen product in the said container 20. The jet of liquid provided by the injection unit 70 to the sliced product can also be previously heated by a heater 71, as schematically shown in FIG. 1. It is also an option of the system of the invention to provide a later heating of both the sliced product and the jet of liquid, typically by means of a mixing heating unit 32 arranged in the recipient 200, as represented in FIG. 1.

In summary, as previously explained, the present invention addresses a system for delivering chilled or frozen beverages in a very short time and in a very hygienic manner, since there is substantially no direct contact between the device 10 and the frozen product; furthermore, the system is more durable and reliable, since in particular moving parts of the device 10 cannot be brought in direct contact with the frozen product and with the slicing element 60. The frozen products used in the device 10 are frozen blocks stored in the user's freezer, in a container 20 suitable to insert in the device 10 of the system of the invention. The user inserts a container 20 with the frozen block of product in the device 10 and it is processed. The first step consists in a slicing of the frozen product block so as to get ice flakes (shaved ice) of the product, as explained; then, these flakes are sprayed by a water jet so as to dissolve whole or part of it (further providing homogenization), depending on the desired final texture and temperature of the beverage. The device parameters are mainly the speed and thickness of the slicing, the positioning of the product block (the product can be layered for complex preparations, as represented schematically in FIGS. 7a and b, for example), the temperature and quantity of water.

From a product point of view, the advantages of the system of the invention are numerous. First, the freezing process allows working with natural and fresh ingredients (nutriments are not damaged) and offer a very long preservation. Then, the slicing method allows cutting small pieces of product enlarging the scope of textures and in-mouth feelings. The variety of ingredients used in the device is very large, including fruits, vegetables, syrups, herbs, cereals, etc. The system of the invention is able to provide real cold and natural and fresh products using a low cost machine. And due to the non-direct contact between the device and the frozen product, which is particularly effected by the shape of the cross-section of the container inner wall 301 facilitating a slicing of the frozen product without directly connecting the device to the frozen product, the quality and hygiene of the final beverage is significantly improved.

Therefore, the system of the invention offers a wide range of real frozen and cold beverages in a very convenient way and with a low-cost machine. Moreover, the advantage of frozen base products are numerous and in line with present beverage trends demanding more freshness and natural products.

An embodiment of the system of the invention uses an additional mixing chamber to complete the shaving and dissolving features. The range of preparations is enlarged thanks to the mixing chamber arranged after the product outlet. Some of the advantages of this additional mixing chamber are the following:
increased number of preparations through mixing/foaming;
increased homogeneity of the beverages;
decrease of dilution ratio (no or less water addition for homogenization);
new textures, notably through foaming;
hygienic system allowing the use of liquid products other than water;
mixing technology can be either built-in the device or presented as an accessory for the device;
can be connected and driven by the master device for complex recipes.

It should be clear to a skilled person that the embodiments shown in the figures are only preferred embodiments, but that, however, also other designs of the system 100, the device 10 and the container 20 can be used.

1. System for delivering frozen or chilled beverages, comprising a device and a container, the container comprising a frozen product and the device being configured for receiving the container and for processing the frozen product of the container to deliver the final beverage;
wherein the device comprises:
a slicing element, the slicing element and the frozen product being relatively rotatable to each other about a rotation axis in order to slice the frozen product, and
a driving unit configured to provide the relative rotation between the slicing element and the frozen product, and
wherein the container comprises a container inner wall being in contact with the frozen product, wherein the container inner wall has a cross-section, which is shaped such that a relative rotation between the container and the frozen product about the rotation axis is blocked.

2. System according to claim 1, wherein the slicing element is designed to remain stationary about the rotation axis, and wherein the driving unit is designed to rotate the container and thus the frozen product about the rotation axis, thereby providing the relative rotation between the slicing element and the frozen product in order to slice the frozen product.

3. System according to claim 1, wherein the container and thus the frozen product are designed to remain stationary about the rotation axis, and wherein the driving unit is designed to rotate the slicing element about the rotation axis, thereby providing the relative rotation between the slicing element and the frozen product in order to slice the frozen product.

4. System according to any one of the preceding claim 1, wherein the cross-section of the container inner wall is elliptically shaped and/or comprises at least one straight section and/or at least one round section.

5. System according to claim 1, wherein the cross-section of the container inner wall has the shape of a polygon.

6. System according to claim 1, wherein the cross-section of the container inner wall is uniform along the rotation axis and/or wherein the cross-section of the container inner wall extends substantially only along the rotation axis.

7. System according to claim 1, wherein the container comprises a moveable lid, and wherein the driving unit is preferably configured to displace the lid in order to displace the frozen product towards the slicing element.

8. System according to claim 7, wherein the lid has a cross-section, which has a shape corresponding to the shape of the cross-section of the container inner wall such that the lid is guidable by the corresponding shapes of the cross-sections of the container inner wall and the lid for displacing the frozen product towards the slicing element.

9. System according to claim 7, wherein the lid comprises a circumferential edge, and wherein the circumferential edge comprises a sealing element for closing the container by the lid in a sealing manner.

10. (canceled)

11. System according to claim 1, wherein the frozen product is displaceable through an opening of the container in order to be displaced towards the slicing element, wherein the container comprises a further lid for closing the opening of the container.

12. System according to claim 1, wherein the container comprises a container outer wall comprising a cross-section being shaped for transferring a rotation of the driving unit of the system about the rotation axis to the container and thus the frozen product in order to slice the frozen product.

13. System according to claim 12, wherein the shape of the cross-section of the container outer wall corresponds to the shape of the cross-section of the container inner wall.

14. System according to claim 1, wherein the container comprises an identification element, wherein the identification element comprises processing parameters for processing the container by the system and/or information of the frozen product contained by the container.

15. System according to claim 1, wherein the system-further comprises an injection unit for providing a jet of liquid to the sliced product in order to dissolve and/or homogenize and/or hydrate the final beverage.

16. System according to claim 1, wherein the system comprises a heating unit adapted to be coupled with the container to at least partially detach the frozen product inside the container before it is sliced.

17. System according to claim 1, wherein the system comprises a mixing chamber for receiving the sliced product.

18. System according to claim 1, wherein the mixing chamber comprises a stirring element for stirring the sliced product in the mixing chamber.

19. System according to claim 1, wherein the system comprises a control unit for controlling at least the driving unit, the injection unit, the heating unit and/or the stirring element.

20. System according to claim 1, wherein the control unit is configured to read the identification element of the container and to control the driving unit, the injection unit, the heating unit and/or the stirring element according to the processing parameters.

21. Method for delivering frozen or chilled beverages with a system comprising a device and a container, the container comprising a frozen product and the device being configured for receiving the container and for processing the frozen product of the container to deliver the final beverage, wherein the device comprises a slicing element, the slicing element and the frozen product being relatively rotatable to each other about a rotation axis in order to slice the frozen product, and a driving unit configured to provide the relative rotation between the slicing element and the frozen product, and wherein the container comprises a container inner wall being in contact with the frozen product, wherein the container inner wall has a cross-section, which is shaped such that a relative rotation between the container and the frozen product about the rotation axis is blocked, the method comprising the steps of:
providing a relative rotation between the slicing element and the frozen product about a rotation axis in order to slice the frozen product, and
blocking a relative rotation between the container and the frozen product about the rotation axis by the shape of the cross-section of the container inner wall.
